(19) United States
(12) Patent Application Publication
(10) Pub. No.: US 2024/0285460 A1
(43) Pub. Date: Aug. 29, 2024

(54) STRETCHING APPARATUS

(71) Applicant: DRAX INC., Anyang-si (KR)

(72) Inventor: Seon Kyung YOO, Seoul (KR)

(73) Assignee: DRAX INC., Anyang-si (KR)

(21) Appl. No.: 18/587,233

(22) Filed: Feb. 26, 2024

(30) Foreign Application Priority Data
Feb. 27, 2023 (KR) 10-2023-0026112
Dec. 5, 2023 (KR) 10-2023-0174676

(51) Int. Cl. A61H 1/02

(52) U.S. Cl. CPC A61H 1/0218; A61H 1/0244; A61H 2201/0161; A61H 2201/1664; A61H 2203/0406

(57) ABSTRACT

A stretching apparatus includes a first stretching member configured to move in a forward and backward direction of a body frame and support a part of a user's body, and a sliding structure configured to slidably move the first stretching member in the forward and backward direction with respect to the body frame, wherein the sliding structure includes a guide rail fixed inside each of the plurality of horizontal frames and a plurality of guide wheels fixed to both end portions of the first stretching member and configured to move along the guide rail inside each of the plurality of horizontal frames.

### CROSS-REFERENCE TO RELATED APPLICATION

This application is based on and claims priority under 35 U.S.C. § 119 to Korean Patent Application No. 10-2023-0026112, filed on Feb. 27, 2023, and Korean Patent Application No. 10-2023-0174676, filed on Dec. 5, 2023, in the Korean Intellectual Property Office, the disclosures of which are incorporated by reference herein in their entireties.

### BACKGROUND

### 1. Field

The disclosure relates to a stretching apparatus for performing various stretching exercises.

### 2. Description of the Related Art

The joints of the human body have a normal range of motion. However, due to lack of exercise, injury, or aging, the range of motion of a joint may decrease. When the range of motion of a joint is reduced, the risk of joint injury may increase and motion functions may decrease.

In order to prevent the range of motion of joints from decreasing, stretching or stretching motions may be performed. Stretching motions are exercises that stretch the muscles, joints, or ligaments of the body. Through the stretching motions, the range of motion of the joints may be increased or the flexibility of the body may be maintained or increased.

A stretching apparatus may be used for assisting during such stretching motions. However, it is known that the human body has more than 300 joints. There are many stretching motions to increase the range of motion of the human body's joints, and also there are many stretching apparatuses for stretching motions.

However, when a plurality of stretching apparatuses are individually provided for each of the various stretching motions, space utilization may be reduced.

### SUMMARY

Provided is a stretching apparatus having a compact size, thereby increasing utilization of exercise spaces in sports centers or gyms.

Provided is a stretching apparatus which enables various stretching motions with a single device, thereby increasing the space utilization of exercise spaces in sports centers or gyms.

Additional aspects will be set forth in part in the description which follows and, in part, will be apparent from the description, or may be learned by practice of the presented embodiments of the disclosure.

According to an aspect of the disclosure, a stretching apparatus includes a body frame, a first stretching member configured to move in a forward and backward direction with respect to the body frame and support a part of a user's body, and a sliding structure configured to slidably move the first stretching member in the forward and backward direction with respect to the body frame.

The body frame may include a plurality of support frames and a plurality of horizontal frames having both end portions supported by the plurality of support frames.

The sliding structure may include a guide rail fixed inside each of the plurality of horizontal frames and a plurality of guide wheels fixed to both end portions of the first stretching member and configured to move along the guide rail inside each of the plurality of horizontal frames.

The first stretching member may include a first movement body supporting a part of the user's body and a wheel support member fixed to both end portions of the first movement body and supporting the plurality of guide wheels.

Each of the plurality of horizontal frames may provide an internal space for accommodating the guide rail and the plurality of guide wheels and may include a guide hole through which the wheel support member passes and which extends in the forward and backward direction to allow the wheel support member to move in the forward and backward direction.

Each of the plurality of horizontal frames may have an insertion hole configured to allow the guide wheel to be inserted into the internal space, and the guide hole may extend from the insertion hole in the forward and backward direction.

The first stretching member may include a 1st-1 stretching member configured to slidably move on the body frame in the forward and backward direction, and a 1st-2 stretching member arranged over the 1st-1 stretching member to be separated from the 1st-1 stretching member and configured to slidably move in the forward and backward direction.

The stretching apparatus may further include a second stretching member configured to rotate about a preset rotation axis in the body frame to adjust an angle thereof with respect to the body frame, wherein the first stretching member may be provided on the body frame such that a movement path of the first stretching member in the forward and backward direction does not interfere with an angle adjustment path of the second stretching member.

A rail support supporting one end portion of the guide rail may be provided inside each of the plurality of horizontal frames, and the rail support may be provided at rear of a rotation axis of the second stretching member.

The stretching apparatus may further include a rotation angle adjuster configured to rotate the second stretching member about a preset rotation axis with respect to the body frame.

The rotation angle adjuster may include an angle adjustment rod arranged below the second stretching member, and a rotation support fixed to the body frame, supporting the second stretching member to rotate about the rotation axis, and having a plurality of angle adjustment grooves into one of which the angle adjustment rod is inserted.

The body frame may further include a plurality of connection frames connecting the plurality of horizontal frames to each other in a left and right direction, and one connection frame adjacent to the second stretching member among the plurality of connection frames may be arranged on a same axis as the rotation axis of the second stretching member.

The connection frame adjacent to the second stretching member may be arranged below the second stretching member.

The rotation support may include a plurality of protruding regions that protrude to define the plurality of angle adjustment grooves, and the plurality of protruding regions may be arranged to be separated from each other in a vertical direction and include a plurality of first protruding regions having a first protrusion height and a plurality of second protruding regions having a second protrusion height.

The plurality of first protruding regions may be arranged at both end portions of the rotation support in the vertical direction and have the first protrusion height that is greater than the second protrusion height, and the plurality of second protruding regions may be arranged between the plurality of first protruding regions in the rotation support.

The rotation angle adjuster may include a rotation shaft, and an angle adjustment handle connecting the rotation shaft to the angle adjustment rod and configured to rotate the angle adjustment rod about the rotation shaft.

According to another aspect of the disclosure, a stretching apparatus includes a body frame, a stretching member configured to adjust an angle thereof with respect to the body frame and to support a part of a user's body, and a rotation angle adjuster configured to rotate the stretching member about a preset rotation axis with respect to the body frame.

The body frame may include a plurality of support frames and a plurality of horizontal frames having both end portions supported by the plurality of support frames.

The rotation angle adjuster may include an angle adjustment rod arranged below the stretching member, and a rotation support fixed to the body frame, supporting the stretching member to rotate about the rotation axis, and having a plurality of angle adjustment grooves into one of which the angle adjustment rod is inserted.

The body frame may further include a plurality of connection frames connecting the plurality of horizontal frames to each other in a left and right direction, and one connection frame adjacent to the stretching member among the plurality of connection frames may be arranged on a same axis as the rotation axis of the stretching member.

The connection frame adjacent to the stretching member may be arranged below the stretching member.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating an example of a stretching apparatus according to an embodiment;

FIG. 2 is an exploded perspective view of the stretching apparatus of FIG. 1;

FIG. 3 is a cross-sectional view of the stretching apparatus of FIG. 1;

FIGS. 4A to 4C are views illustrating a stretching apparatus according to another embodiment;

FIG. 5 is an enlarged perspective view of a first stretching member and a peripheral part thereof in a stretching apparatus according to an embodiment;

FIG. 6 is an enlarged view of a part of the stretching apparatus of FIG. 5;

FIG. 7 is an enlarged view of another part of the stretching apparatus of FIG. 5;

FIG. 8 is a bottom perspective view of a stretching apparatus according to an embodiment;

FIG. 9 is a view illustrating a process of assembling a 1st-1 stretching member to a first horizontal frame for moving in the stretching apparatus of FIG. 8;

FIG. 10 is a view illustrating a process of assembling a 1st-2 stretching member to a second horizontal frame for moving in the stretching apparatus of FIG. 8;

FIG. 11 is an enlarged perspective view of a second stretching member of a stretching apparatus according to an embodiment;

FIG. 12 is a cross-sectional view illustrating a second stretching member of a stretching apparatus according to an embodiment;

FIG. 13 is an enlarged perspective view of a second stretching member in a stretching apparatus according to the embodiment;

FIG. 14 is a view illustrating an operation of the second stretching member in the stretching apparatus of FIG. 13;

FIG. 15 is a view illustrating an operation of the second stretching member in the stretching apparatus of FIG. 13;

FIG. 16 is a perspective view illustrating a part of a stretching apparatus to describe a third stretching member of the stretching apparatus according to an embodiment;

FIG. 17 is an enlarged view of a part of FIG. 16 to describe an operating structure of the third stretching member of FIG. 16;

FIG. 18 is an enlarged view of a part of the third stretching member of FIG. 17;

FIG. 19 is a rear view illustrating a third stretching member of a stretching apparatus according to an embodiment;

FIG. 20 is a left view of a height support for adjusting a height of a third stretching member of a stretching apparatus according to the embodiment;

FIG. 21 is a cross-sectional horizontal perspective view of a stretching apparatus according to an embodiment;

FIG. 22 is a cross-sectional horizontal perspective view of a stretching apparatus according to an embodiment;

FIG. 23 is a view illustrating a stretching motion using a 1st-1 stretching member of a stretching apparatus according to an embodiment;

FIG. 24 is a view illustrating a stretching motion using a 1st-2 stretching member of a stretching apparatus according to an embodiment;

FIG. 25 is a view illustrating a stretching motion using a second stretching member of a stretching apparatus according to an embodiment;

FIG. 26 is a view illustrating a stretching motion using a third stretching member of a stretching apparatus according to an embodiment; and

FIG. 27 is a view illustrating a smart gym environment including a plurality of pieces of smart exercise equipment, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, several embodiments of the disclosure will be described in detail with reference to the attached drawings such that those skilled in the art in which the disclosure belongs easily practice the disclosure.

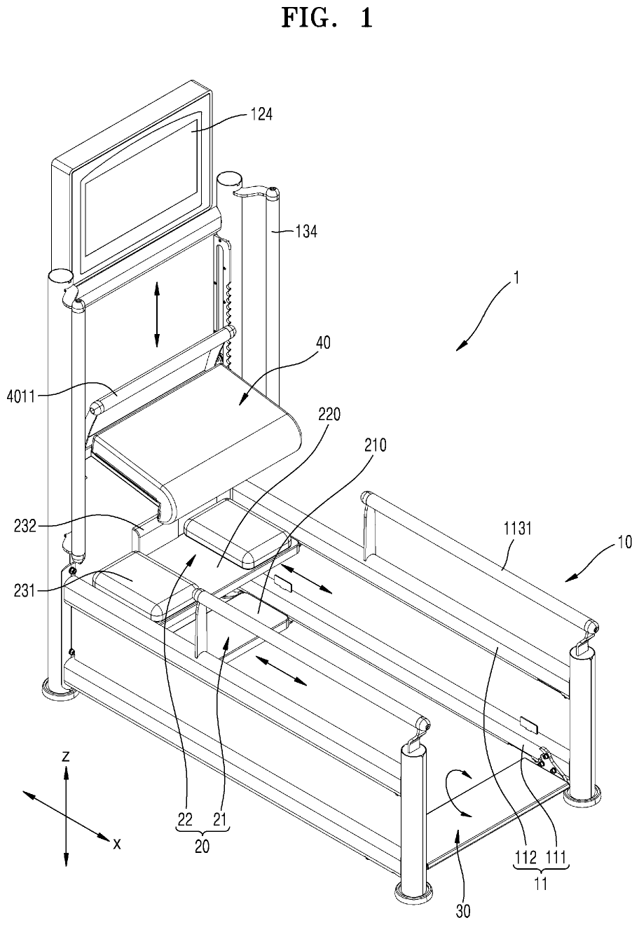

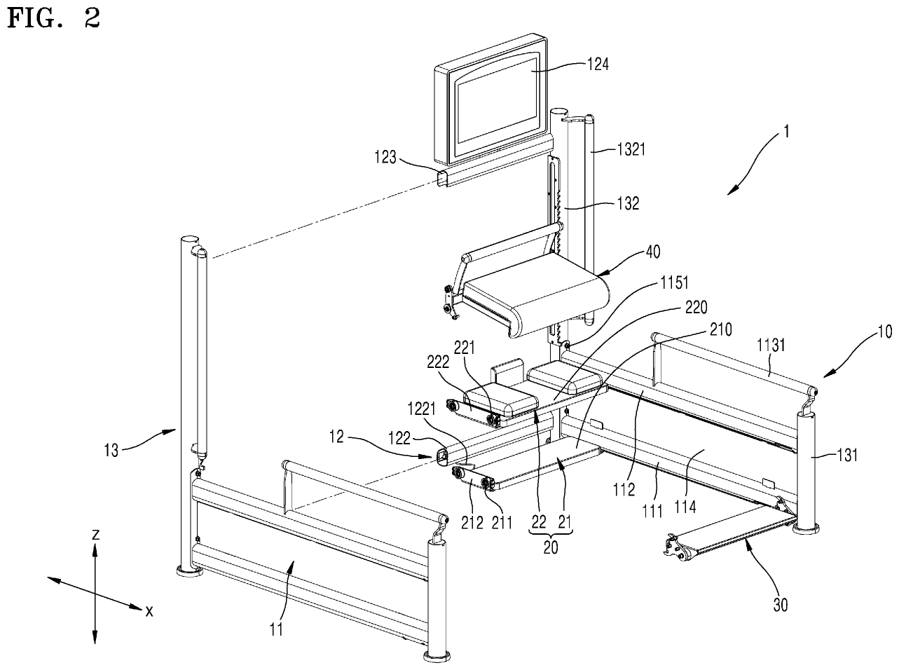

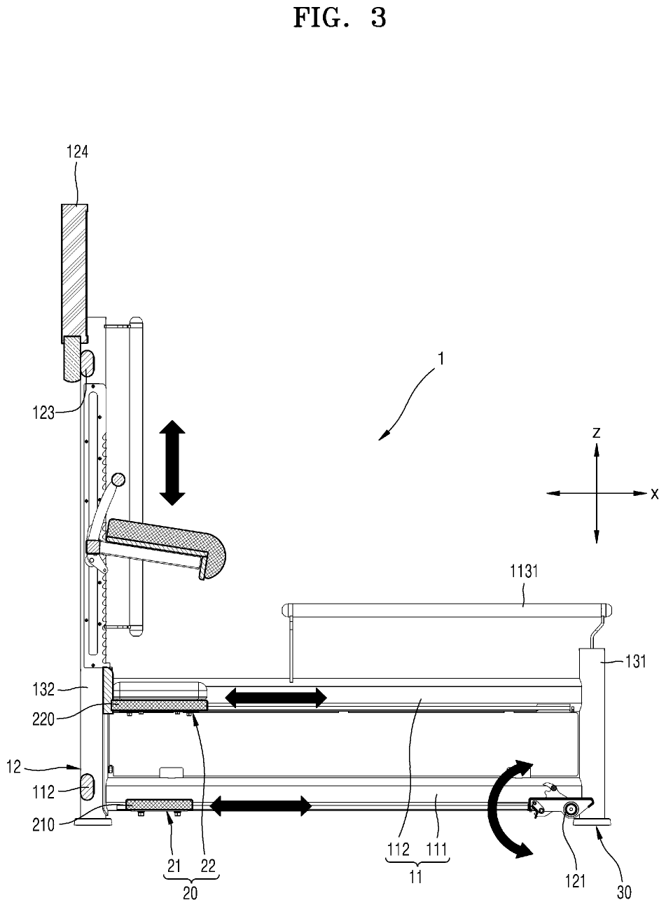

FIG. 1 is a perspective view illustrating an example of a stretching apparatus 1 according to an embodiment. FIG. 2 is an exploded perspective view of the stretching apparatus 1 of FIG. 1. FIG. 3 is a cross-sectional view of the stretching apparatus 1 of FIG. 1.

Referring to FIG. 1, the stretching apparatus 1 according to an embodiment may include a body frame 10 and at least one stretching member installed on the body frame 10. For example, the stretching apparatus 1 may include a plurality of stretching members.

The plurality of stretching members may include a first stretching member 20, a second stretching member 30, and a third stretching member 40, which have different operating characteristics.

The first stretching member 20 may be provided in the body frame 10 to slide in a forward and backward direction X. The first stretching member 20 may be supported on the body frame 10 to be movable in the forward and backward direction X.

The first stretching member 20 may move along a first movement path when moving in the forward and backward direction X. The first movement path may be a straight path extending in the forward and backward direction X. The first stretching member 20 moves in the forward and backward direction X and has a foremost position and a rearmost position. The first stretching member 20 may be arranged on the body frame 10 to slide between the foremost position and the rearmost position along the first movement path.

The first stretching member 20 may include a plurality of stretching members. For example, the first stretching member 20 may include a 1st-1 stretching member 21 and a 1st-2 stretching member 22, which are arranged in parallel to each other.

The 1st-1 stretching member 21 may be provided on the body frame 10 along the forward and backward direction X to be slidable. The 1st-2 stretching member 22 may be above the 1st-1 stretching member 21 to be separated from the 1st-1 stretching member 21 and to be slidable in the forward and backward direction X.

The second stretching member 30 may be provided in the body frame 10 to be angle-adjustable. For example, the second stretching member 30 may be provided in the body frame 10 to be rotatable about a preset rotation axis 301.

The second stretching member 30 may have a second movement path when an angle is adjusted. The second movement path may be a path through which a rear end of the second stretching member 30 passes when the second stretching member 30 rotates about a rotation axis 301.

The third stretching member 40 may be provided in the body frame 10 to be height-adjustable. The third stretching member 40 may be provided in the body frame 10 to be position-adjustable in a vertical direction Z.

The third stretching member 40 may have a third movement path through which the third stretching member 40 moves to adjust the height of the third stretching member 40. The third movement path may be the longest path through which the third stretching member 40 may move in the vertical direction Z.

In the stretching apparatus 1 according to an embodiment, the first stretching member 20, the second stretching member 30, and the third stretching member 40 may be arranged in the body frame 10 such that the respective movement paths do not interfere with each other. As described above, a plurality of stretching members capable of performing various stretching motions are arranged in one apparatus, and thus, the space efficiency of exercise spaces in a sports centers or a gymnasium may be increased.

Referring to FIGS. 1 to 3, the stretching apparatus 1 according to the embodiment may include the first stretching member 20, the second stretching member 30, and the third stretching member 40 installed in the body frame 10 such that movement paths of the first, second, and third stretching members 20, 30, and 40 do not interfere with each other.

The first movement path through which the first stretching member 20 moves in the forward and backward direction X may be separated from the second movement path when an angle of the second stretching member 30 is adjusted. For example, the second stretching member 30 may be at the same height as the first stretching member 20 and be on a further front side than a foremost position of the first stretching member 20. For example, the second stretching member 30 may be at the same height as the 1st-1 stretching member 21 and be on a further front side than the 1st-1 stretching member 21.

The first movement path of the first stretching member 20 may be separated from the third movement path of the third stretching member 40. For example, the third stretching member 40 may overlap the first stretching member 20 in the vertical direction Z when the first stretching member 20 is in a rearmost position and may be above the first stretching member 20 to be separated from the first stretching member 20. For example, the third stretching member 40 may overlap the 1st-2 stretching member 22 in the vertical direction Z when the 1st-2 stretching member 22 is in a rearmost position and may be above the 1st-2 stretching member 22 to be separated from the 1st-2 stretching member 22.

The body frame 10 according to the embodiment includes a plurality of support frames 13 and a plurality of horizontal frames 11 supported by the plurality of support frames 13. The body frame 10 may have a structure in which the plurality of support frames 13 are separately assembled with the plurality of horizontal frames 11, but the disclosure is not limited thereto, and the plurality of support frames 13 may be respectively integrated with the plurality of support frames 13.

One end portion of each of the plurality of support frames 13 may be supported by a bottom surface and may extend in the vertical direction Z. A cross-sectional shape of each of the plurality of support frames 13 may be circular. However, the cross-sectional shape of each of the plurality of support frames 13 is not limited thereto and may be polygonal or oval.

The plurality of support frames 13 may include a pair of first support frames 131 and a pair of second support frames 132 separated from the pair of first support frames 131 at the rear of the pair of first support frames 131.

The pair of first support frames 131 may be parallel to each other on a front side of the stretching apparatus 1. Each of the pair of first support frames 131 may have a first height.

The pair of second support frames 132 may be parallel to each other on a rear side of the stretching apparatus 1. Each of the pair of second support frames 132 may have a second height. The second height may be greater than the first height. For example, the second height may be 1.5 times or more than the first height. For example, the second height may be two to three times the first height. The pair of second support frames 132 may include a first handle 1321 extending in the vertical direction Z.

The plurality of horizontal frames 11 may include a pair of first horizontal frames 111 and a pair of second horizontal frames 112. The pair of first horizontal frames 111 may be parallel to each other in the forward and backward direction X, and the pair of second horizontal frames 112 may be parallel to each other in the forward and backward direction X. The plurality of horizontal frames 11 may include a second handle 1131 extending in the forward and backward direction X.

The pair of first horizontal frames 111 may be parallel to the pair of second horizontal frames 112 in the vertical direction Z. An extension length of each of the pair of first horizontal frames 111 may be equal to an extension length of each of the pair of second horizontal frames 112. The second horizontal frame 112 may be above the first horizontal frame 111 to be separated from the first horizontal frame 111. A decoration plate 114 may be between the first horizontal frame 111 and the second horizontal frame 112. A material of the decoration plate 114 may be wood but is not limited thereto and may change. For example, the material of the decoration plate 114 may be plastic or metal.

The first horizontal frame 111 and the second horizontal frame 112 may be between the first support frame 131 and the second support frame 132. One end portion of the first horizontal frame 111 may be supported by the first support frame 131, and the other end portion of the first horizontal frame 111 may be supported by the second support frame 132. One end portion of the second horizontal frame 112 may be supported by the first support frame 131, and the other end portion of the second horizontal frame 112 may be supported by the second support frame 132.

Each of the first horizontal frame 111 and the second horizontal frame 112 may be supported by the first support frame 131 and the second support frame 132. For example, one end portion of the first horizontal frame 111 and one end portion of the second horizontal frame 112 may be directly fixed to the first support frame 131. The other end portion of the first horizontal frame 111 and the other end portion of the second horizontal frame 112 may be fixed to the second support frame 132 by a support plate 1151. However, the structure, in which each of the first horizontal frame 111 and the second horizontal frame 112 is supported by the first support frame 131 and the second support frame 132, is not limited thereto and may change.

A horizontal interval between the plurality of horizontal frames 11 or between the plurality of support frames 13 may be maintained by a connection frame 12. For example, the connection frame 12 may include a first connection frame 121, a second connection frame 122, and a third connection frame 123. The body frame 10 may have a structure in which the plurality of horizontal frames 11, the plurality of support frames 13, and the plurality of connection frames 12 are separately assembled with each other, but the disclosure is not limited thereto, and the plurality of horizontal frames 11, the plurality of support frames 13, and the plurality of connection frames 12 may be respectively integrated with each other.

The first connection frame 121 may be between the pair of first horizontal frames 111. For example, the first connection frame 121 may be on a front side between the pair of first horizontal frames 111.

The second connection frame 122 may be between the pair of second support frames 132. For example, the second connection frame 122 may be on a lower side between the pair of second support frames 132. An elastic member 1221 may be between the second connection frame 122 and the 1st-1 stretching member 21 such that the elastic member 1221 provides elastic force in a direction in which the 1st-1 stretching member 21 approaches the second connection frame 122.

The third connection frame 123 may be between the pair of second support frames 132. For example, the third connection frame 123 may be on an upper side between the pair of second support frames 132. A display panel 124 may be on the third connection frame 123.

Referring to FIGS. 1 to 3, in the stretching apparatus 1 according to the embodiment, the first stretching member 20 may be between the plurality of horizontal frames 11. The first stretching member 20 may be between the plurality of horizontal frames 11 and may include first movement bodies 210 and 220 for supporting a part of a user's body.

For example, the 1st-1 stretching member 21 may be between the pair of first horizontal frames 111. The 1st-1 stretching member 21 may move in an extension direction of the first horizontal frame 111. The 1st-1 stretching member 21 may move in the forward and backward direction X. The 1st-1 stretching member 21 may include the first movement body 210 that supports a part of a user's body and is movable in the forward and backward direction X.

The 1st-2 stretching member 22 may be above the 1st-1 stretching member 21 to be separated from the 1st-1 stretching member 21. When a user performs a stretching motion by using the 1st-1 stretching member 21, the 1st-1 stretching member 21 and the 1st-2 stretching member 22 may have a preset gap therebetween in the vertical direction Z such that the 1st-1 stretching member 21 does not collide with the 1st-2 stretching member 22. For example, the interval in the vertical direction Z between the 1st-1 stretching member 21 and the 1st-2 stretching member 22 may be about 15 cm to about 45 cm.

The 1st-2 stretching member 22 may be between the pair of second horizontal frames 112. The 1st-2 stretching member 22 may move in an extension direction of the second horizontal frame 112. The 1st-2 stretching member 22 may move in the forward and backward direction X. A movable distance of the 1st-2 stretching member 22 is longer than a movable distance of the 1st-1 stretching member 21.

The 1st-2 stretching member 22 may include the first movement body 220 that supports a part of a user's body and is movable in the forward and backward direction X. The 1st-2 stretching member 22 may include a pair of pads 231. The pair of pads 231 may be separated from each other in a horizontal direction on the 1st-2 stretching member 22. The pair of pads 231 may be separated from each other in the left and right directions on an upper portion of the first movement body 220.

The 1st-2 stretching member 22 may further include a foot support 232 provided to support a user's foot. A user may slidingly move the 1st-2 stretching member 22 in the forward and backward direction X while supporting a foot on the foot support 232.

The 1st-1 stretching member 21 and the 1st-2 stretching member 22 may be supported on the body frame 10 to be slidable in the forward and backward direction X. For example, the 1st-1 stretching member 21 may be supported by the pair of first horizontal frames 111 to be movable in the forward and backward direction X. For example, the 1st-2 stretching member 22 may be supported by the pair of second horizontal frames 112 to be movable in the forward and backward direction X.

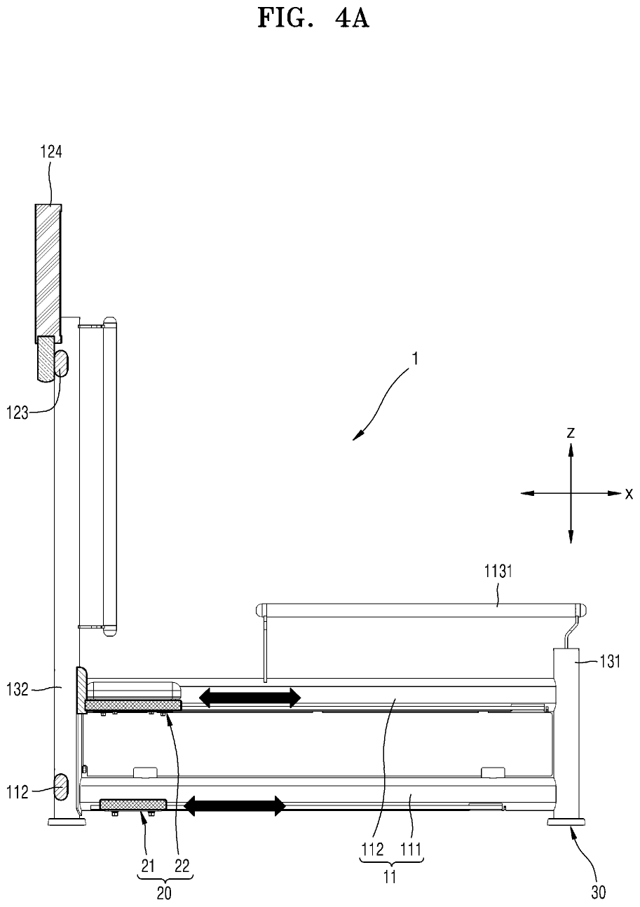

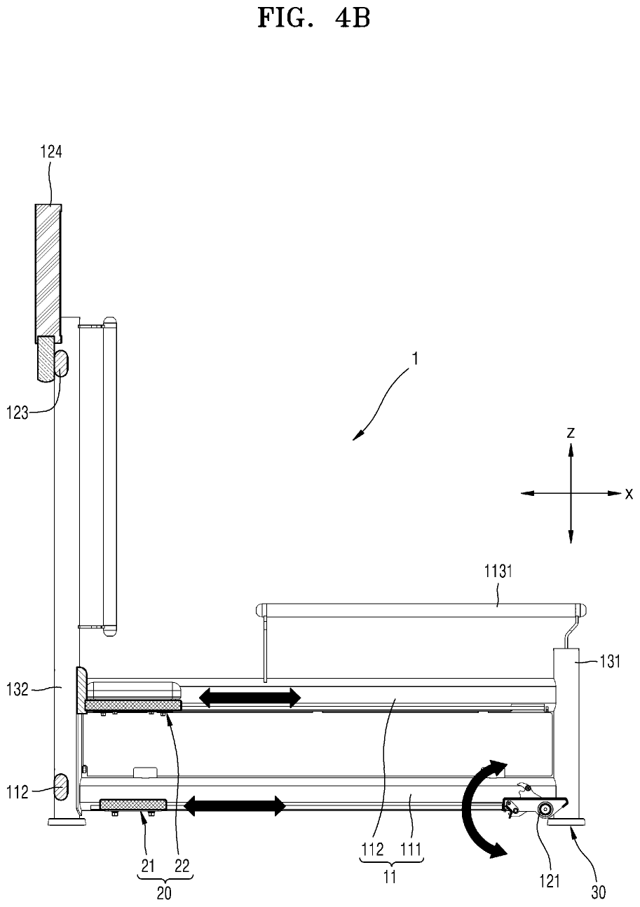

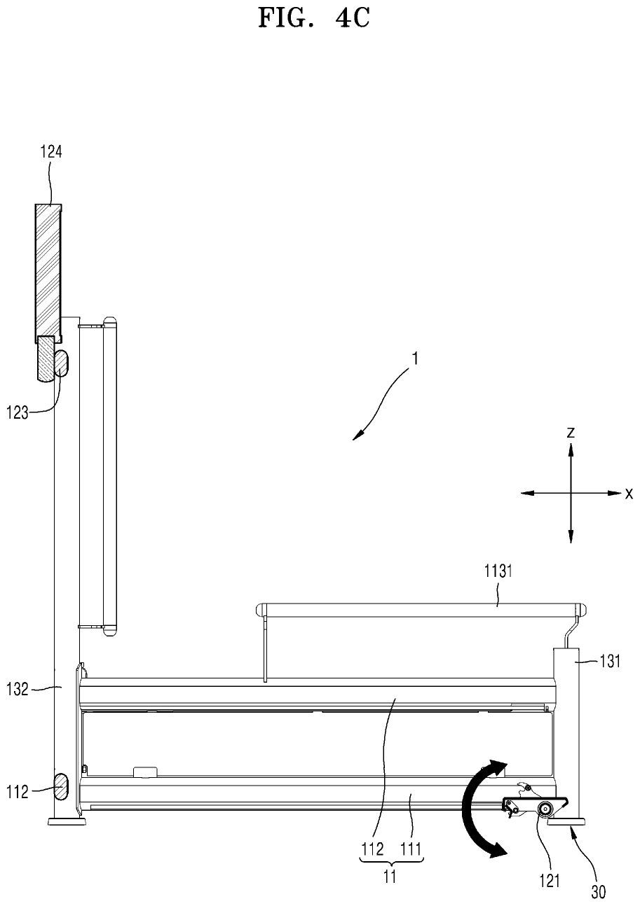

Although the embodiment described above describes an example in which the stretching apparatus 1 includes the first stretching member 20, the second stretching member 30, and the third stretching member 40, the embodiment is not limited thereto. For example, as illustrated in FIG. 4A, the stretching apparatus 1 may include the first stretching member 20 and may not include the second stretching member 30 and the third stretching member 40. For example, as illustrated in FIG. 4B, the stretching apparatus 1 may include the first stretching member 20 and the second stretching member 30 and may not include the third stretching member 40. For example, as illustrated in FIG. 4C, the stretching apparatus 1 may include the second stretching member 30 and may not include the first stretching member 20 and the third stretching member 40.

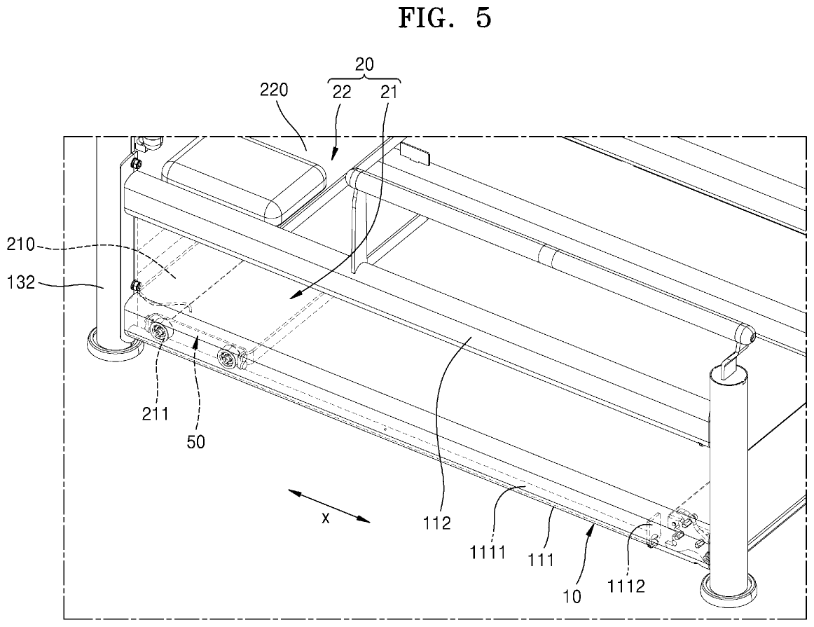

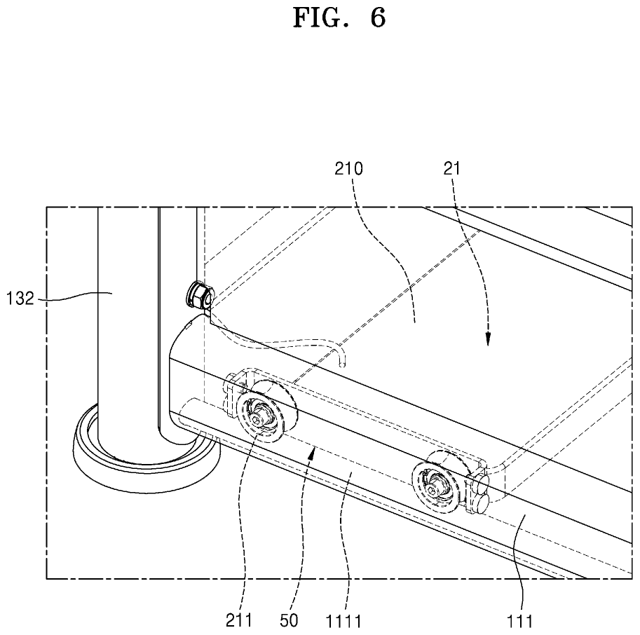

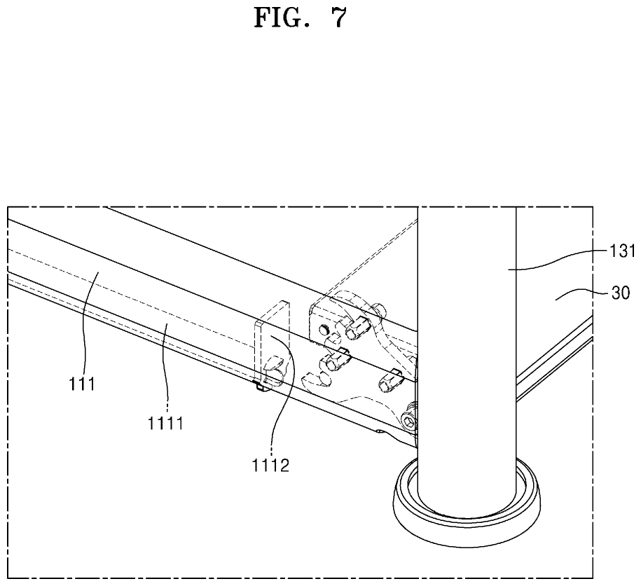

FIG. 5 is an enlarged perspective view of the first stretching member 20 in the stretching apparatus 1 according to the embodiment. FIG. 6 is an enlarged view of a part of the stretching apparatus 1 of FIG. 5, and FIG. 7 is an enlarged view of another part of the stretching apparatus 1 of FIG. 5.

Referring to FIGS. 5 to 7, the stretching apparatus 1 according to the embodiment may include the body frame 10, the first stretching member 20 that is movable in the forward and backward direction X with respect to the body frame 10, and a sliding structure 50 that may slide in the forward and backward direction with respect to the body frame 10.

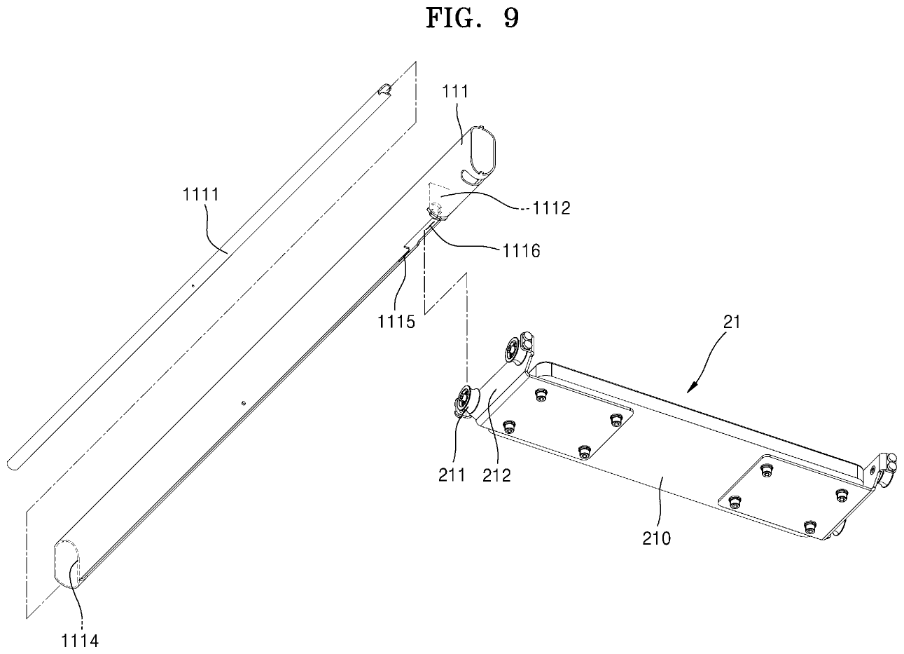

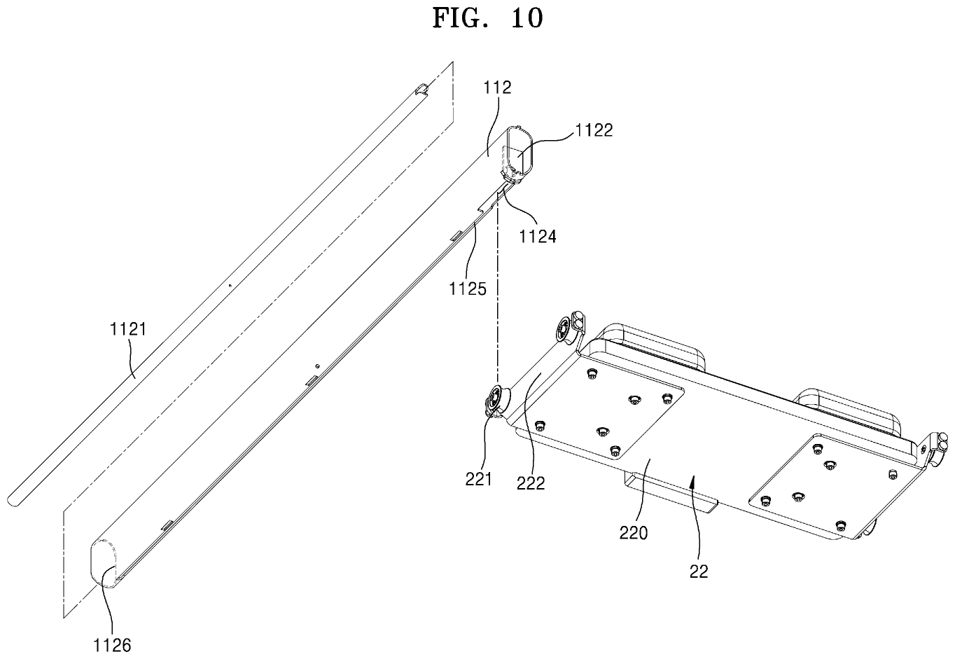

The first stretching member 20 may include first movement bodies 210 and 220 and wheel support members 212 and 222 respectively fixed to both end portions of the first movement bodies 210 and 220 (see FIGS. 9 and 10).

The sliding structure 50 may include guide rails installed to be fixed inside the horizontal frame and guide wheels fixed to both end portions of the first stretching member 20. The guide wheels may move along the guide rails within the horizontal frame. The guide wheels may be supported by the wheel support members 212 and 222 of the first stretching member 20.

For example, the first guide rail 1111 may be on the first horizontal frame 111 to guide the movement of the 1st-1 stretching member 21 in the forward and backward direction X. The first guide rail 1111 may extend in the forward and backward direction X. The first guide rail 1111 may be fixed inside the first horizontal frame 111. For example, one end portion of the first guide rail 1111 may be supported by the second support frame 132, and the other end portion of the first guide rail 1111 may be supported by a first stopper 1112 provided on the first horizontal frame 111.

Both end portions of the 1st-1 stretching member 21 in the horizontal direction may include a first guide wheels 211 provided to move along the first guide rail 1111. The first guide wheel 211 may be supported by the wheel support member 212 of the 1st-1 stretching member 21.

The first guide wheel 211 of the first stretching member 20 may be inside the first horizontal frame 111 and may move along the first guide rail 1111 in the forward and backward direction X. A front movement distance of the 1st-1 stretching member 21 may be limited by the first stopper 1112. Accordingly, a movement distance of the 1st-1 stretching member 21 in the forward and backward direction X may be less than a length of the first horizontal frame 111.

The horizontal frame may provide an internal space for accommodating the guide rails and the guide wheels. For example, the first horizontal frame 111 may provide an internal space for accommodating the first guide rail 1111 and the first guide wheel 211. For example, the second horizontal frame 112 may provide an internal space for accommodating the second guide rail 1121 and the second guide wheel 221.

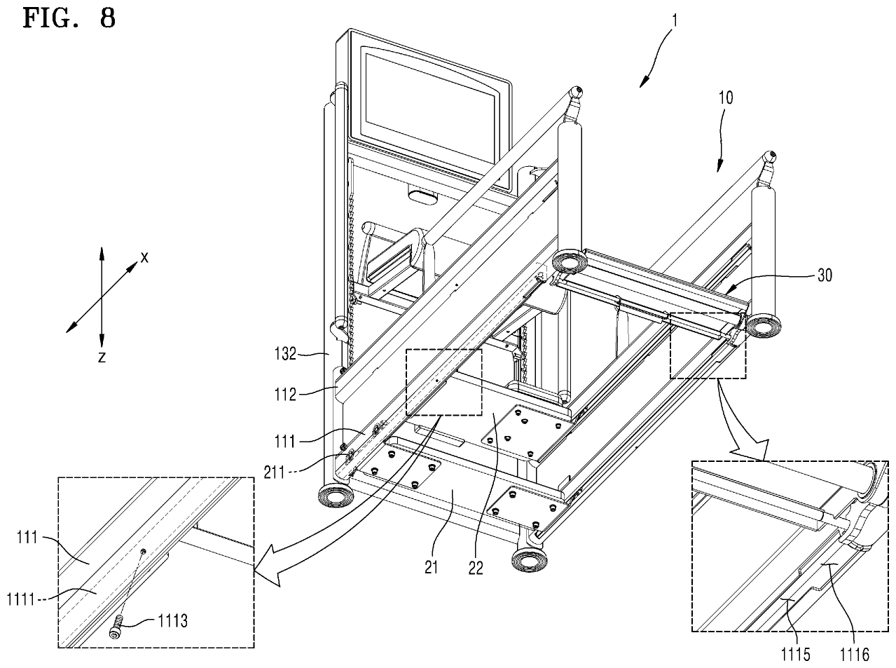

FIG. 8 is a bottom perspective view of the stretching apparatus 1 according to an embodiment. FIG. 9 is a view illustrating a process of assembling the 1st-1 stretching member 21 with the first horizontal frame 111 such that the 1st-1 stretching member 21 is movable, in the stretching apparatus 1 of FIG. 8. FIG. 10 is a view illustrating a process of assembling the 1st-2 stretching member 22 with the second horizontal frame 112 such that the 1st-2 stretching member 22 is movable, in the stretching apparatus 1 of FIG. 8.

Referring to FIGS. 8 and 9, a horizontal frame of the stretching apparatus 1 according to the embodiment may include a configuration for inserting a guide rail and a guide wheel. For example, an opening for inserting a guide rail may be provided in at least one of both end portions of the horizontal frame in the forward and backward direction X. The horizontal frame may include a guide hole extending in the forward and backward direction through which a wheel support member may move in the forward and backward direction. The horizontal frame may have an insertion hole that is greater than a diameter and thickness of the guide wheel such that the guide wheel may be inserted into an internal space. A length of the insertion hole in the forward and backward direction is greater than a diameter of the guide wheel, and a width of the insertion hole in the left and right direction is greater than a thickness of the guide wheel in a left and right direction. A guide hole may extend in the forward and backward direction from the insertion hole.

For example, the first horizontal frame 111 may have a structure into which the first guide rail 1111 and the first guide wheel 211 are inserted. For example, a first opening 1114 through which the first guide rail 1111 is inserted may be formed in at least one of both end portions of the first horizontal frame 111 in the forward and backward direction X. A lower portion of the first horizontal frame 111 may include a first guide hole 1115 through which a first wheel support member 212 supporting the first guide wheel 211 passes and a first insertion hole 1116 which is formed at one end portion of the first guide hole 1115 and through which the first guide wheel 211 is insertable into the first horizontal frame 111. A length of the first insertion hole 1116 in the forward and backward direction X is greater than a diameter of the first guide wheel 211, and a width of the first insertion hole 1116 in the left and right direction Y is greater than a thickness of the first guide wheel 211 in the left and right direction Y. The first guide hole 1115 may extend from the first insertion hole 1116 in the forward and backward direction X. Referring to FIG. 9, in a manufacturing process of the stretching apparatus 1, the first guide wheel 211 is inserted into the first horizontal frame 111 through the first insertion hole 1116 of the first horizontal frame 111. Next, the first guide rail 1111 is inserted into the first horizontal frame 111 through the first opening 1114 of the first horizontal frame 111. Inside the first horizontal frame 111, a position of the 1st-1 stretching member 21 is adjusted such that the first guide wheel 211 is safely placed on the first guide rail 1111. One end portion of the first guide rail 1111 inserted into the first horizontal frame 111 may be supported by a first stopper 1112. A position of the first guide wheel 211 safely placed on the first guide rail 1111 may be maintained in the vertical direction Z by gravity and move in the forward and backward direction X along the first guide rail 1111.

Referring to FIG. 10, the second horizontal frame 112 may have a structure into which the second guide rail 1121 and a second guide wheel 221 are inserted. For example, at least one of both end portions of the second horizontal frame 112 in the forward and backward direction X may have a second opening 1124 through which the second guide rail 1121 is inserted. An end portion of the second guide rail 1121 inserted through the second opening 1124 may be fixed by the second stopper 1122.

A lower portion of the second horizontal frame 112 may include a second guide hole 1125 through which the second wheel support member 222 supporting the second guide wheel 221 passes and a second insertion hole 1126 which is formed at one end portion of the second guide hole 1125 and through which the second guide wheel 221 is insertable into the second horizontal frame 112. A length of the second insertion hole 1126 in the forward and backward direction X is greater than a diameter of the second guide wheel 221, and a width of the second insertion hole 1126 in the left and right direction Y is greater than a thickness of the second guide wheel 221 in the left and right direction Y. The second guide hole 1125 may extend from the second insertion hole 1126 in the forward and backward direction X.

Similarly to the process of inserting the first guide wheel 211 into the first horizontal frame 111, the second guide wheel may be inserted into the second horizontal frame 112.

Referring again to FIG. 8, the guide rail inserted into the horizontal frame may be fixed to the horizontal frame by a fixing member. For example, the first guide rail 1111 may be fixed to the first horizontal frame 111 by a fixing member 1113. The first guide rail 1111 may be prevented from moving in the forward and backward direction X in the first horizontal frame 111 by the fixing member 1113. However, the fixing member 1113 is an optional component and may be omitted as needed. For example, both end portions of the first guide rail 1111 may be supported by the second support frame 132 and the first stopper 1112 and may also be fixed inside the first horizontal frame 111 without the fixing member 1113.

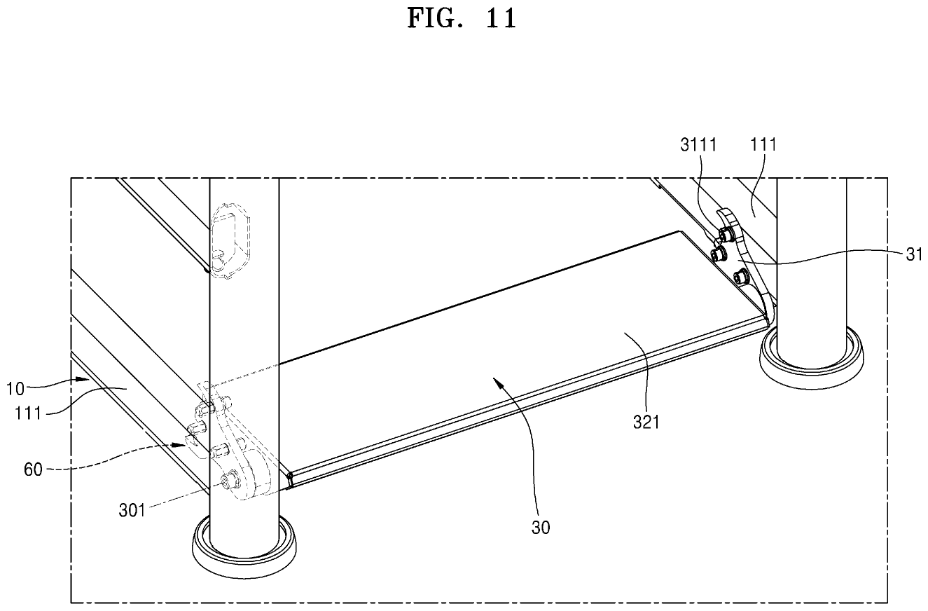

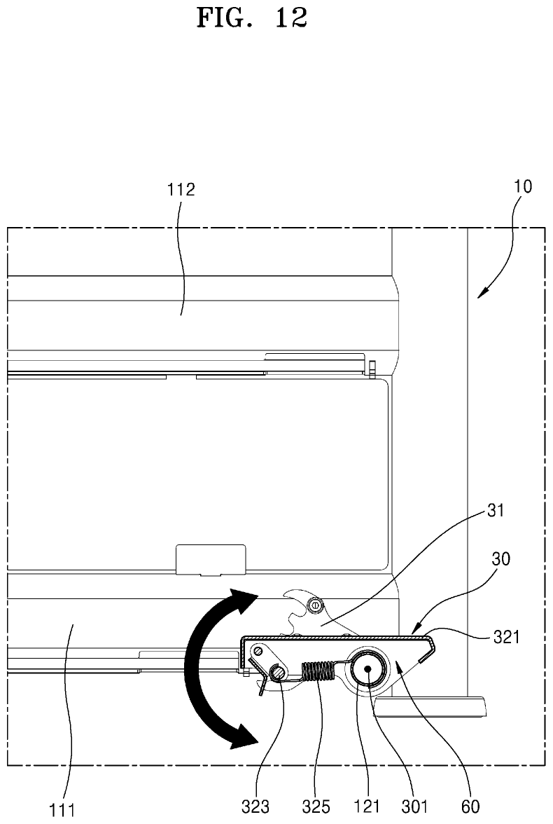

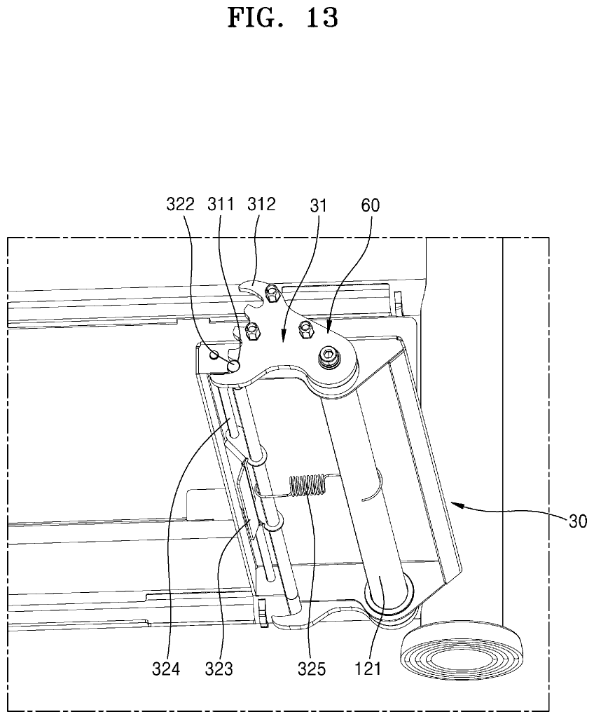

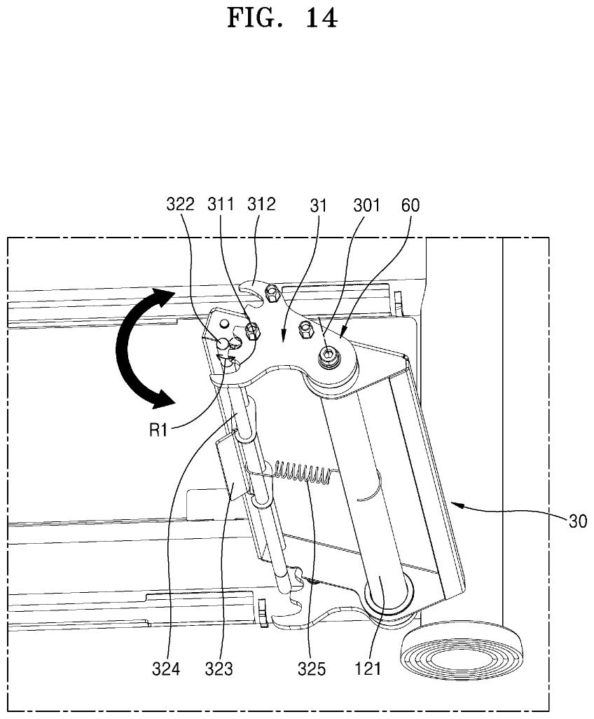

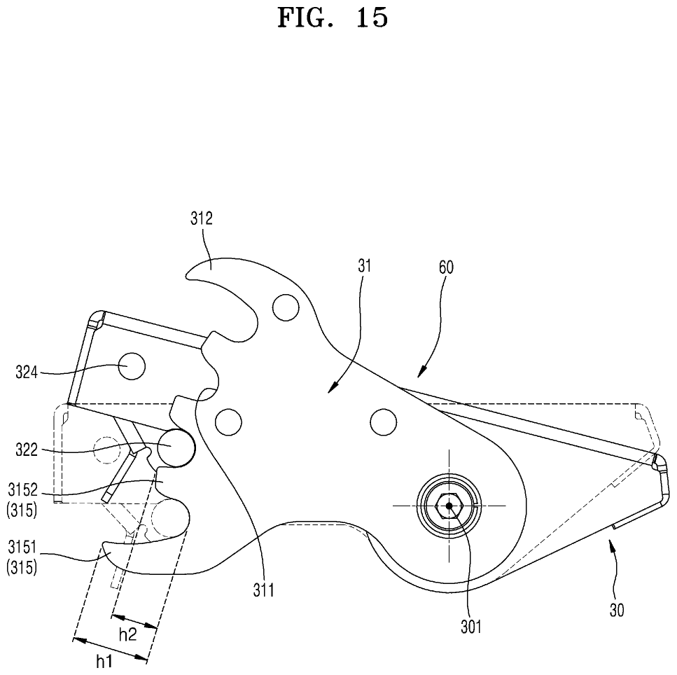

FIG. 11 is an enlarged perspective view of the second stretching member 30 of the stretching apparatus 1 according to the embodiment, and FIG. 12 is a cross-sectional view illustrating the second stretching member 30 of the stretching apparatus 1 according to the embodiment. FIG. 13 is an enlarged perspective view of the second stretching member 30 of the stretching apparatus 1 according to the embodiment. FIG. 14 is a view illustrating an operation of the second stretching member 30 in the stretching apparatus 1 of FIG. 13. FIG. 15 is a view illustrating an operation of the second stretching member 30 in the stretching apparatus 1 of FIG. 13.

Referring to FIGS. 1, 11, and 12, the stretching apparatus 1 according to the embodiment may include the second stretching member 30 and a rotation angle adjuster 60 provided to cause the second stretching member 30 to rotate about a preset rotation axis with respect to the body frame 10.

The second stretching member 30 may support a part of a user's body. For example, the second stretching member 30 may include a support plate 321 for a user to place the sole of the user's foot thereon.

The second stretching member 30 may be arranged between the plurality of horizontal frames 11. The second stretching member 30 may be between the pair of first horizontal frames 111. The second stretching member 30 may be on a front side between the pair of first horizontal frames 111.

The second stretching member 30 may be configured to adjust its angle with respect to the body frame 10. The second stretching member 30 may be supported on the first horizontal frame 111 to be rotatable about a preset rotation axis 301.

Referring to FIGS. 11 to 13, the rotation angle adjuster 60 may include an angle adjustment rod 322 arranged below the second stretching member 30 and a rotation support portion 31 that is fixed on the body frame 10 and supports the second stretching member 30 to rotate about the rotation axis 301.

For example, the angle adjustment rod 322 may be below the second stretching member 30. For example, the angle adjustment rod 322 may be below the support plate 321.

The rotation angle adjuster 60 may include a rotation shaft 324 and an angle adjustment handle 323 that connects the rotation shaft 324 to the angle adjustment rod 322.

The rotation shaft 324 may be below the second stretching member 30. Both end portions of the rotation shaft 324 may be supported by the support plate 321. The rotation shaft 324 may be separated from the rotation shaft 301.

The angle adjustment handle 323 may be provided such that the angle adjustment rod 322 rotates about the rotation shaft 324. The angle adjustment handle 323 may connect a central portion of the angle adjustment rod 322 to a central portion of the rotation shaft 324.

The rotation support 31 may be fixed to the body frame 10 by the fixing member 3111. For example, the rotation support 31 may be fixed to the first horizontal frame 111. For example, the rotation support 31 may be fixed to the first horizontal frame 111 by the fixing member 3111.

The rotation support 31 may include a plurality of angle adjustment grooves 311 into which the angle adjustment rod 322 may be inserted. When the angle adjustment rod 322 is inserted into any one of the plurality of angle adjustment grooves 311, an angle or posture of the second stretching member 30 may be determined.

Referring to FIGS. 14 and 15, when the angle adjustment handle 323 is pulled by an external force applied by a user or so on, the angle adjustment rod 322 connected to the angle adjustment handle 323 rotates around the rotation shaft 324 to be separated from and the angle adjustment groove 311 of the rotation support 31. In a state where the angle adjustment rod 322 is separated from the angle adjustment groove 311, the second stretching member 30 may be rotated about a rotation axis. Thereafter, when the angle adjustment rod 322 is inserted into another angle adjustment groove 311 by releasing the external force applied to the angle adjustment handle 323, the second stretching member 30 may have a different angle with respect to the body frame 10.

The second stretching member 30 may further include a pressing member 325 that presses the angle adjustment rod 322 to rotate in a preset rotation direction about the rotation shaft 324. The pressing member 325 may be an elastic body that provides elastic force. For example, the elastic body may include a springs or a rubber member but is not limited thereto. One end portion of the pressing member 325 may be supported by the angle adjustment rod 322, and the other end portion of the pressing member 325 may be supported by the first connection frame 121. By the pressing member 325, the angle adjustment rod 322 may maintain a state in which the angle adjustment rod 322 is inserted into the angle adjustment groove 311.

The rotation support 31 may include a rotation stopper 312 that limits a movement range of the angle adjustment rod 322 such that the angle adjustment rod 322 separated from the angle adjustment groove 311 is not separated from the rotation support 31. For example, the rotation stoppers 312 protruding rearward may be provided in both end portions of the rotation support 31 in the vertical direction Z. Here, protruding toward the rear may be interpreted as protruding in a direction away from the rotation axis 301.

For example, the rotation support 31 may include a plurality of protruding regions 315 provided to define the plurality of angle adjustment grooves 311. The plurality of protruding regions 315 may each have a shape protruding toward the rear. The plurality of angle adjustment grooves 311 may be defined by adjacent protruding regions 315. In other words, the angle adjustment groove 311 may be between adjacent protruding regions 315.

The plurality of protruding regions 315 may be approximately separated from each other in a vertical direction. The plurality of protruding regions 315 may include a plurality of first protruding regions 3151 and a plurality of second protruding regions 3152 respectively having protrusion heights h1 and h2.

The plurality of first protruding regions 3151 may be at both end portions of the rotation support 31 in the vertical direction. The plurality of second protruding regions 3152 may be between the plurality of first protruding regions 3151 in the rotation support 31.

The first protruding region 3151 may function as the rotation stopper 312. The protrusion height h1 of the first protrusion region 3151 may be greater than the protrusion height h2 of the second protruding region 3152. The protrusion height h1 of the first protruding region 3151 may be greater than a movable distance R1 of the angle adjustment rod 322. The protrusion height h2 of the second protruding region may be less than the movable distance R1 of the angle adjustment rod 322. The movable distance R1 of the angle adjustment rod 322 may be determined based on a rotation radius of the angle adjustment rod 322 and an elastic force of the pressing member 325.

As described above, as the rotation support 31 has the plurality of protruding regions 315, the angle adjustment rod 322 is movable to be selectively inserted into one of the plurality of angle adjustment grooves 311, and the angle adjustment rod 322 may be prevented from separating from the rotation support 31.

The first connection frame 121 for maintaining an interval between the pair of first horizontal frames 111 may be arranged on the same axis as the rotation axis 301 of the second stretching member 30. By arranging the first connection frame 121 on the same axis as the rotation axis 301 of the second stretching member 30, a size of the stretching apparatus 1 may be reduced, and interference with a user's stretching motion may be prevented.

When the first connection frame 121 is placed at the rear of the second stretching member 30, interference with the movement of the 1st-1 stretching member 21 in the forward and backward direction X may occur, and in order to avoid this, a length of the stretching apparatus 1 may be increased in the forward and backward direction X. When the first connection frame 121 is in front of the second stretching member 30, for example, between the pair of first support frames 131, the first connection frame 121 may interfere with an operation using the second stretching member 30 or may interfere with an operation using the 1st-2 stretching member 22. When the first connection frame 121 is below the second stretching member 30 and is not on the same axis as the rotation axis 301 of the second stretching member 30, the first connection frame 121 may interfere with the rotation of the second stretching member 30. In addition, in the stretching apparatus 1 according to the embodiment, the first connection frame 121 is on the same axis as the rotation axis 301 of the second stretching member 30, and accordingly, a length of the stretching apparatus 1 in the forward and backward direction X may be reduced, and a user's stretching motion is not interfered.

The second stretching member 30 may be at the same height as the first stretching member 21. That is, the second stretching member 30 may partially overlap the 1st-1 stretching member 21 in the forward and backward direction X. Here, being arranged at the same height may mean that at least a part of the second stretching member 30 is arranged to overlap the 1st-1 stretching member 21 in the forward and backward direction.

For example, the 1st-1 stretching member 21 may be installed on the first horizontal frame 111 to be movable in the forward and backward direction X, and the second stretching member 30 may be installed on the first horizontal frame 111 to be rotatable. The first horizontal frame 111 may include a first stopper 1112 that limits a movement distance of the 1st-1 stretching member 21. The first stopper 1112 may prevent the 1st-1 stretching member 21 from coming into contact with the second stretching member 30.

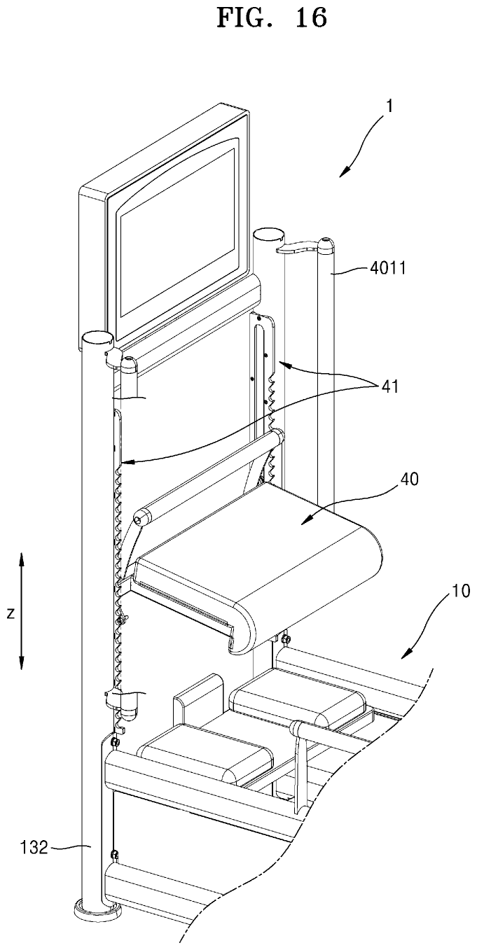

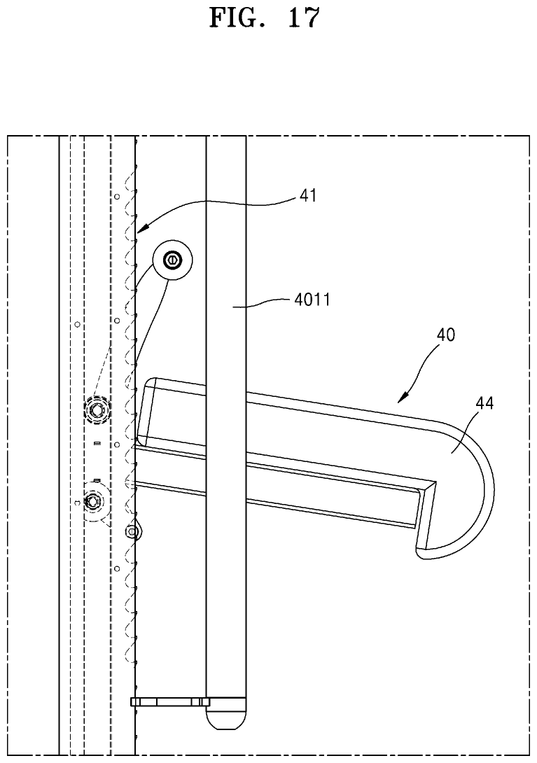

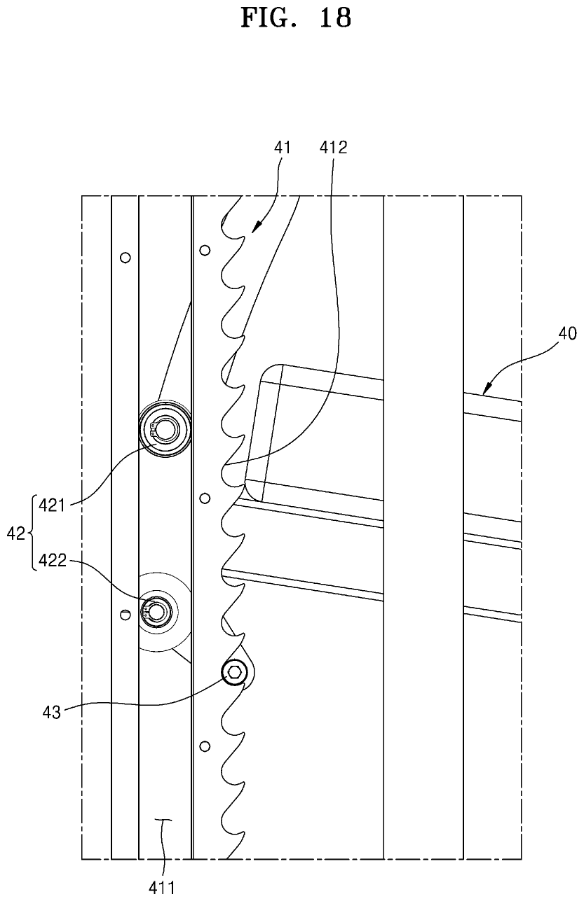

FIG. 16 is a perspective view illustrating a part of the stretching apparatus 1 to describe the third stretching member 40 of the stretching apparatus 1 according to the embodiment, and FIG. 17 is an enlarged view of a part of FIG. 16 to describe an operating structure of the third stretching member 40 of FIG. 16. FIG. 18 is an enlarged view of a part of the third stretching member 40 of FIG. 17.

Referring to FIGS. 16 to 19, the third stretching member 40 according to the embodiment may be provided in the body frame 10 to be height-adjustable in the vertical direction Z. For example, the third stretching member 40 may be installed on the second support frame 132 such that a height of the third stretching member 40 may be adjusted in the vertical direction Z. The third stretching member 40 may include a third handle 4011 extending in the horizontal direction.

The third stretching member 40 may be between the pair of second support frames 132. The second support frame 132 may be provided with a height support 41 for supporting the third stretching member 40 at a plurality of heights.

The height support 41 may include a height guide slit 411 extending in the vertical direction Z and a plurality of height adjustment grooves 412 arranged in the vertical direction Z.

at least one height adjustment bearing 42 that is inserted into the height guide slit 411 of the height support 41, and a height adjustment protrusion 43 that is separated from the height adjustment bearing 42 and is insertable into one of the plurality of height adjustment grooves 412 may be respectively formed at both end portions of the third stretching member 40.

The at least one height adjustment bearing 42 may be plural. For example, the height guide bearing 42 may include a first bearing 421 and a second bearing 422 which are inserted into the height guide slit 411.

The first bearing 421 is above the second bearing 422, and a diameter of the first bearing 421 may be greater than a diameter of the second bearing 422. The diameter of the first bearing 421 may be less than a width of the height guide slit 411.

The diameter of the second bearing 422 may be less than the diameter of the first bearing 421. The diameter of the second bearing 422 may be less than the width of the height guide slit 411. A difference between the diameter of the second bearing 422 and the width of the height guide slit 411 may be greater than a difference between the diameter of the first bearing 421 and the width of the height guide slit 411. Accordingly, the second bearing 422 may rotate about the first bearing 421.

Positions of the first bearing 421, the second bearing 422, and the height adjustment protrusion 43 are fixed to both end portions of the third stretching member 40. Accordingly, as the second bearing 422 rotates about the first bearing 421, the height adjustment protrusion 43 may also rotate about the first bearing 421. Due to the rotation of the height adjustment protrusion 43, the height adjustment protrusion 43 may be separated from the height adjustment groove 412 and may be inserted into another height adjustment groove 412. In this way, a height of the third stretching member 40 may be adjusted by selectively inserting the height adjustment protrusion 43 into the plurality of height adjustment grooves 412.

A seat pad 44 may be provided on the third stretching member 40. The seat pad 44 may have a shape in which a front portion is curved. Accordingly, an upper portion of the seat pad 44 may support a part of a user's lower body, or a front portion of the seat pad 44 may support the user's back or waist.

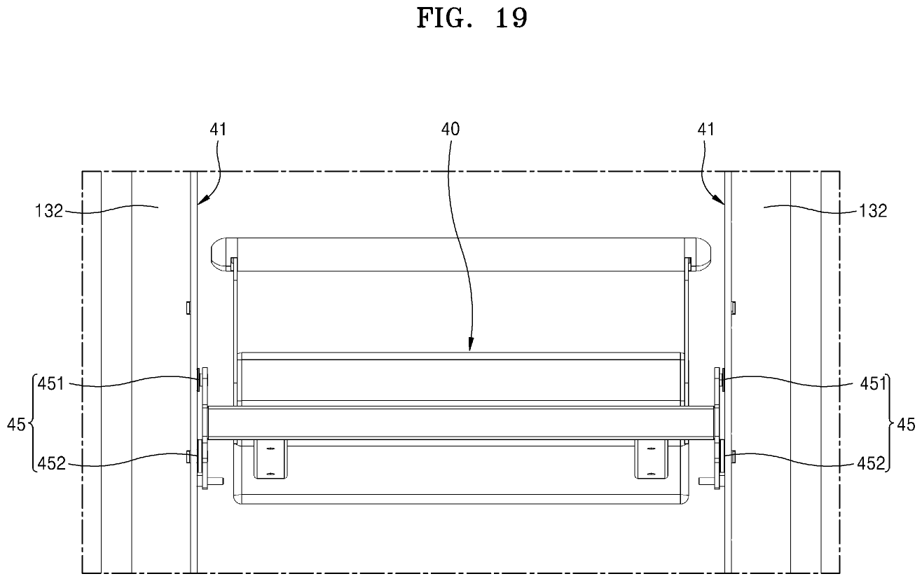

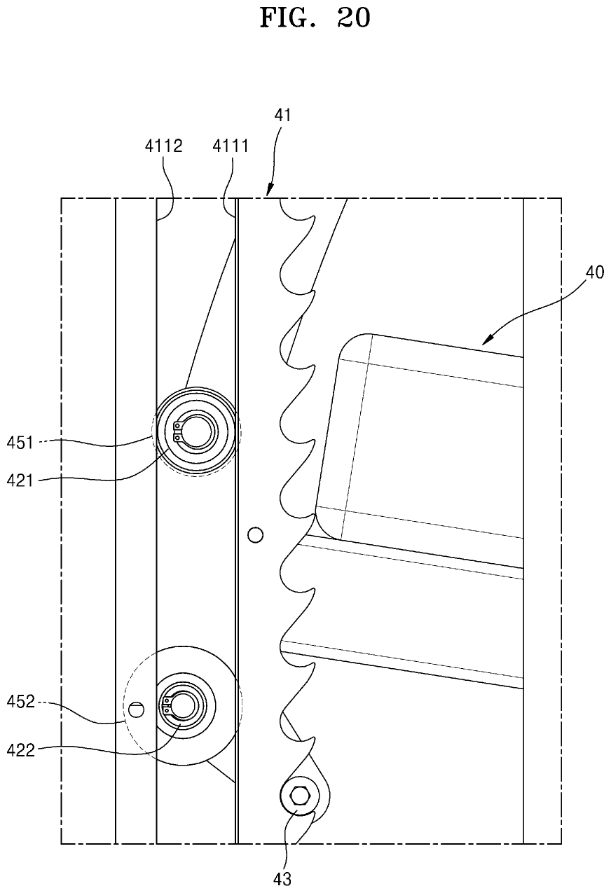

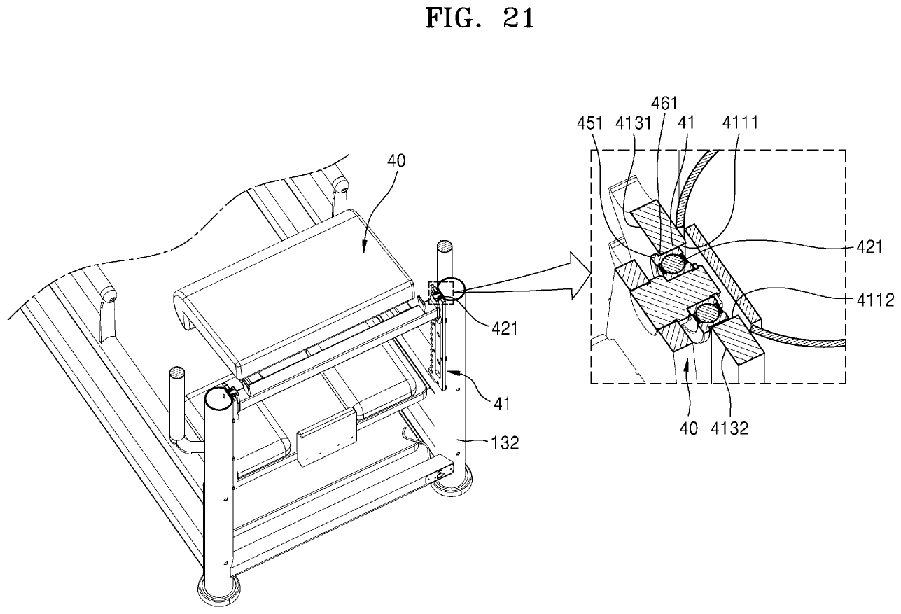

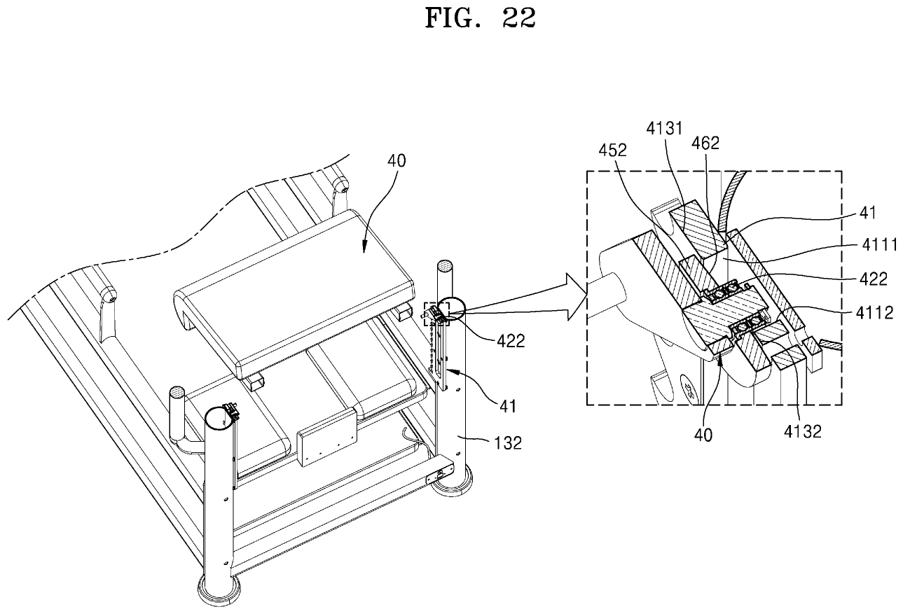

FIG. 19 is a rear view illustrating the third stretching member 40 of the stretching apparatus 1 according to an embodiment. FIG. 20 is a left view of the height support 41 for adjusting a height of the third stretching member 40 of the stretching apparatus 1 according to an embodiment. FIG. 21 is a cross-sectional horizontal perspective view of the stretching apparatus 1 according to an embodiment, and FIG. 22 is a cross-sectional horizontal perspective view of the stretching apparatus 1 according to an embodiment.

Referring to FIGS. 19 and 20, the stretching apparatus 1 according to the embodiment may further include a separation prevention member 45 configured to prevent the third stretching member 40 from being separated from the height support 41 in a process of adjusting a height of the third stretching member 40.

The separation prevention member 45 may be inside the height adjustment bearing 42 and may have a width greater than a width of the height guide slit 411. Accordingly, the separation prevention member 45 may prevent the height adjustment bearing 42 from being separated from the height guide slit 411.

The separation prevention member 45 may include a first flange 451 inside the first bearing 421 and a second flange 452 inside the second bearing 422. The first flange 451 may have a diameter greater than a diameter of the first bearing 421. A difference in diameter between the first flange 451 and the first bearing 421 may be 20% or less of a diameter of the first bearing 421. The second flange 452 may have a diameter greater than a diameter of the second bearing 422. A difference in diameter between the second flange 452 and the second bearing 422 may be 100% or more and 400% or less of the diameter of the second bearing 422. The diameter of the second flange 452 may be greater than the diameter of the first flange 451.

At least one of the height support 41 and the separation prevention member 45 may have an anti-jamming slope configured to prevent the separation prevention member 45 from being caught in the height support 41 during a vertical movement of the third stretching member 40.

For example, referring to FIG. 21, a first inclined surface 461 may be provided in a portion of the height support 41 facing the first flange 451. The first inclined surface 461 may be between the first inner surface 4131 of the height support 41 and a first guide surface 4111 defining the height guide slit 411. The first inclined surface 461 may have an inclination with respect to the first inner surface 4131. In this way, even when a part of the first flange 451 comes into contact with a second inner surface 4132 of the height support 41, another part of the first flange 451 may not come into contact with the first inner surface 4131 of the height support 41 due to the first inclined surface 461.

For example, referring to FIG. 22, a second inclined surface 462 may be provided on a portion of the second flange 452 facing the height support 41. Due to the second inclined surface 462, a distance from the height support 41 increases as a distance from the center of the second flange 452 increases. Accordingly, when the second bearing 422 comes into contact with or approaches a second guide surface 4112 defining the height guide slit 411, the second inclined surface 462 of the second flange 452 may not come into contact with the first inner surface 4131 of the height support 41 even when the second inclined surface 462 comes into contact with the second inner surface 4132 of the height support part 41.

Hereinafter, a stretching motion using the stretching apparatus 1 described above is described.

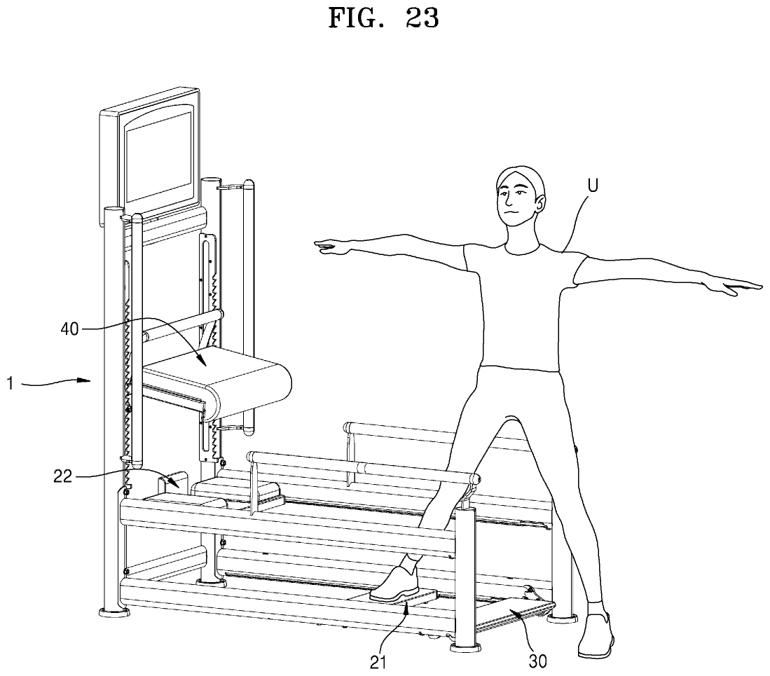

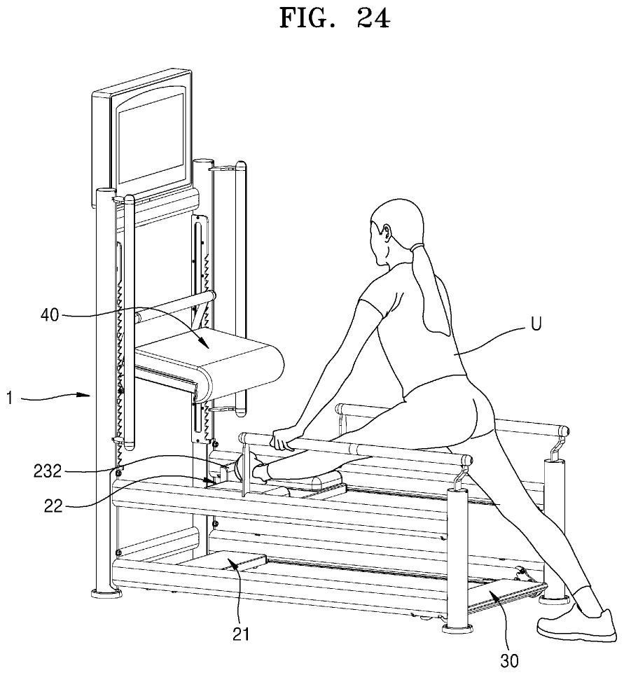

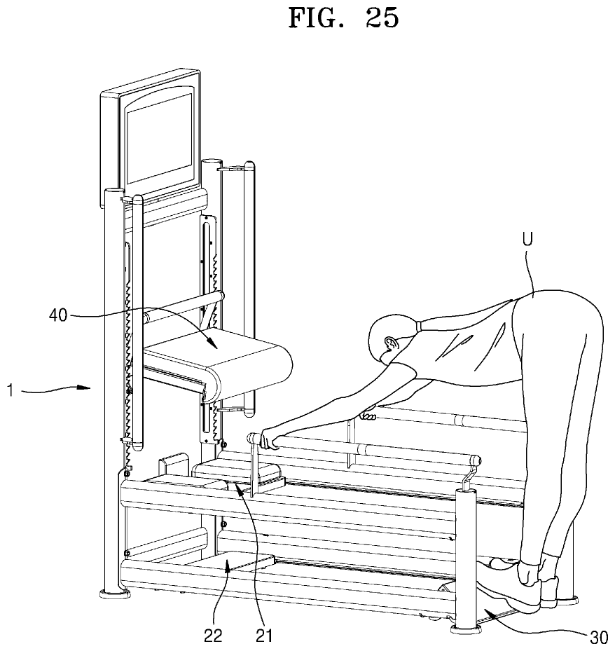

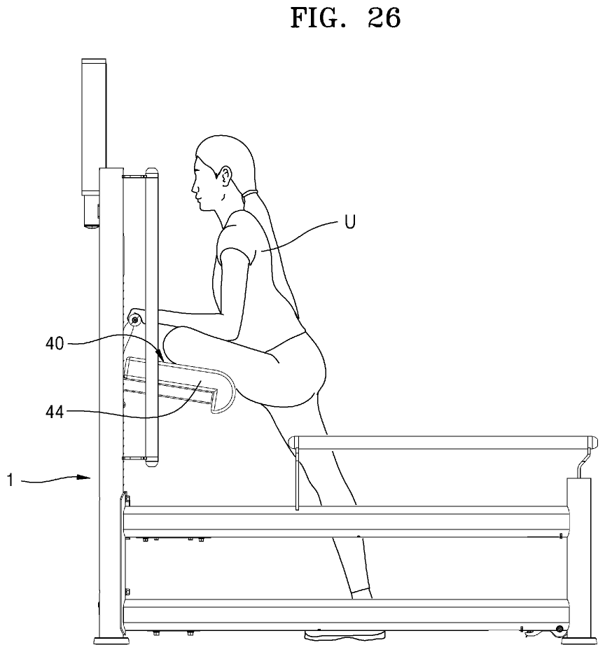

FIG. 23 is a view illustrating a stretching motion using a 1st-1 stretching member of the stretching apparatus 1 according to an embodiment, and FIG. 24 is a view illustrating a stretching motion using a 1st-2 stretching member of the stretching apparatus 1 according to an embodiment. FIG. 25 is a view illustrating a stretching motion using a second stretching member of the stretching apparatus 1 according to an embodiment, and FIG. 26 is a view illustrating a stretching motion using a third stretching member of the stretching apparatus 1 according to an embodiment.

Referring to FIG. 23, a user may place his or her foot on an upper portion of the 1st-1 stretching member 21 of the stretching apparatus 1 and perform adductor muscle stretching. However, the motion using the 1st-1 stretching member 21 is not limited thereto and may change. For example, a user may perform hamstring stretching while supporting the heel of the foot on the upper portion of the 1st-1 stretching member 21, perform adductor muscle stretching while supporting at least a part of the sole of the foot on the upper portion of the 1-1 stretching member 21, or perform iliopsoas muscle stretching while supporting the forefoot on the upper portion of the 1st-1 stretching member 21. That is, the user may place his or her feet on the upper portion of the 1st-1 stretching member 21 of the stretching apparatus 1 and perform one of the hamstring stretching motion, the adductor muscle stretching motion, and the iliopsoas muscle stretching motion. In addition to the stretching motions, other motions may also be made by using the 1st-1 stretching member 21. For example, a user may make a lunge motion by using the 1st-1 stretching member 21.

Referring to FIG. 24, a user may place his or her feet or knees on an upper portion of the 1st-2 stretching member 22 and make one of iliopsoas muscle stretching, hamstring stretching, and hip stretching. For example, a user may perform hamstring stretching while supporting the feet on the foot support 232 of the 1st-2 stretching member 22, perform iliopsoas muscle stretching while supporting the shin on one of the pair of pads 231, or perform hip stretching while supporting a lower body by bending the knees on the pair of pads 231.

Referring to FIG. 25, a user may place both feet or one foot on the second stretching member 30 and perform calf or pullback stretching. For example, a user bends down while supporting both feet on the inclined second stretching member 30 to perform latissimus dorsi muscle stretching, shoulder stretching, or hamstring or calf stretching, or places both feet or perform calf stretching while supporting both feet or one foot on the inclined second stretching member 30.

Referring to FIG. 26, a user may perform various types of stretching while supporting part of a lower body or part of an upper body on the third stretching member 40. For example, the user may perform hip stretching while bending and supporting the knees on an upper portion of the seat pad 44 of the third stretching member 40, or perform thoracic spine extension stretching or lumbar extension stretching by leaning the body rearwards while leaning the back or waist on the front portion of the seat pad 44.

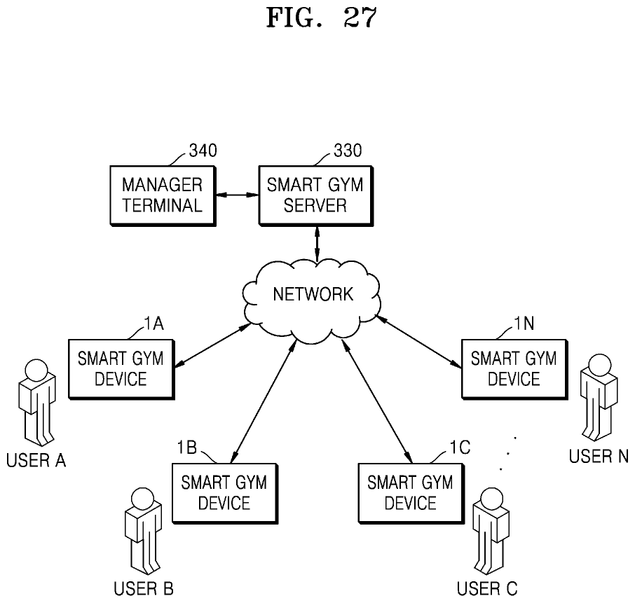

FIG. 27 is a diagram illustrating a smart gym environment including a plurality of pieces of smart exercise equipment according to an embodiment.

Referring to FIG. 27, a plurality of pieces of smart exercise equipment 1A, 1B, 1C, and 1N are connected to a smart gym server 330 through a network. A manager, such as a trainer or a smart gym manager, may access the smart gym server 330 through a manager terminal 340.

Users USER A, USER B, USER C, USER N who come to exercise at a smart gym verifies his or her identity by using a terminal, such as a wearable device or smartphone, and then enters the smart gym. For example, a user may enter after member verification by tagging the terminal to an unmanned terminal, such as a kiosk, at a smart gym entrance by using near field communication (NFC) or radio frequency identification (RFID). Information on a user whose membership is confirmed may be transmitted from the smart gym server 330 to at least one of the smart exercise equipment 1A, 1B, 1C, and 1N through the network. At least one of the smart exercise equipment 1A, 1B, 1C, and 1N may be the stretching apparatus 1 according to the embodiment described above.

When a user approaches one of the smart exercise equipment 1A, 1B, 1C, and 1N and tags a wearable device to one of the smart exercise equipment 1A, 1B, 1C, and 1N, the corresponding smart exercise equipment may automatically set an exercise program customized to a user's ability level and exercise performance history based on the information received from the smart gym server 330.

The smart gym server 330 may store user information of the users USER A, USER B, USER C, and USER N, device information of the smart exercise equipment 1A, 1B, 1C, and 1N, and information used for managing other facilities or smart devices.

When a manager, such as a trainer, registers a user-customized exercise program in the manager terminal 340, the exercise process information stored in the smart gym server 330 may be updated. The smart exercise equipment 1A, 1B, 1C, and 1N may receive exercise process information from the smart gym server 330 connected through a network.

In addition, although the embodiment described above provides a stretching apparatus as one of exercise equipment of the smart exercise equipment 1A, 1B, 1C, and 1N, the disclosure is not limited thereto, and any exercise equipment for exercise may be applied in various ways.

According to an embodiment, a stretching apparatus having a compact size and structure may be provided to increase space utilization of an exercise space in a sports center or a gym.

According to a preferred embodiment, a stretching apparatus, by which various types of stretching may be performed with a single device, may be provided to increase space utilization of an exercise space in a sports center or a gym.

Embodiments according to the disclosure may be implemented in the form of a computer program that may be executed through various components of a computer, and such a computer program may be recorded on a computer-readable storage medium.

The exercise posture analysis device described above may be implemented in the form of a computer-readable storage medium including at least one program that stores instructions executable by a processor. The computer is a device capable of calling stored instructions from a storage medium and performing operations according to the disclosed embodiments in response to the called instructions, and may include an exercise posture analysis device according to the disclosed embodiments. Computer-readable storage media may include magnetic media such as a hard disk, a floppy disk, and a magnetic tape, optical recording media, such as compact disk-read only memory (CD-ROM) and a digital video disk (DVD), magneto-optical media, such as floptical disks, and hardware devices specifically configured to store and execute program instructions, such as ROM, random access memory (RAM), and flash memory. Furthermore, storage media may include intangible media implemented in a form that may be transmitted through a network, and for example, the storage media may also be a form of media implemented in the form of software or an application that may be transmitted and distributed through a network.

In addition, a computer program may be specifically designed and configured for the disclosure or may be known and available to those skilled in the art of computer software. Examples of computer programs may include not only machine language codes that are generated by a compiler but also high-level language code that may be executed by a computer by using an interpreter or so on.

As described above, various embodiments are provided. Those skilled in the art in which the disclosure belongs will understand that the disclosure may be implemented in a modification form without departing from the essential characteristics of the disclosure. Therefore, the disclosed embodiments should be considered from an illustrative perspective rather than a restrictive perspective. The scope of the disclosure is indicated in the claims rather than the foregoing description, and all differences within the equivalent scope should be construed as being included in the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A stretching apparatus comprising:
a body frame;
a first stretching member configured to move in a forward and backward direction with respect to the body frame and support a part of a user's body; and
a sliding structure configured to slidably move the first stretching member in the forward and backward direction with respect to the body frame,
wherein the body frame includes a plurality of support frames and a plurality of horizontal frames having both end portions supported by the plurality of support frames, and
the sliding structure includes a guide rail fixed inside each of the plurality of horizontal frames and a plurality of guide wheels fixed to both end portions of the first stretching member and configured to move along the guide rail inside each of the plurality of horizontal frames.

2. The stretching apparatus of claim 1, wherein the first stretching member includes:
a first movement body supporting a part of the user's body; and
a wheel support member fixed to both end portions of the first movement body and supporting the plurality of guide wheels.

3. The stretching apparatus of claim 2, wherein each of the plurality of horizontal frames provides an internal space for accommodating the guide rail and the plurality of guide wheels, and includes a guide hole through which the wheel support member passes and which extends in the forward and backward direction to allow the wheel support member to move in the forward and backward direction.

4. The stretching apparatus of claim 3, wherein each of the plurality of horizontal frames has an insertion hole configured to allow the guide wheel to be inserted into the internal space, and
the guide hole extends from the insertion hole in the forward and backward direction.

5. The stretching apparatus of claim 1, wherein the first stretching member includes:
a 1st-1 stretching member configured to slidably move on the body frame in the forward and backward direction; and
a 1st-2 stretching member arranged over the 1st-1 stretching member to be separated from the 1st-1 stretching member and configured to slidably move in the forward and backward direction.

6. The stretching apparatus of claim 1, further comprising a second stretching member configured to rotate about a preset rotation axis in the body frame to adjust an angle thereof with respect to the body frame,
wherein the first stretching member is provided on the body frame such that a movement path of the first stretching member in the forward and backward direction does not interfere with an angle adjustment path of the second stretching member.

7. The stretching apparatus of claim 6, wherein a rail support supporting one end portion of the guide rail is provided inside each of the plurality of horizontal frames, and
the rail support is provided at rear of a rotation axis of the second stretching member.

8. The stretching apparatus of claim 6, further comprising a rotation angle adjuster configured to rotate the second stretching member about a preset rotation axis with respect to the body frame.

9. The stretching apparatus of claim 8, wherein the rotation angle adjuster includes:
an angle adjustment rod arranged below the second stretching member; and
a rotation support fixed to the body frame, supporting the second stretching member to rotate about the rotation axis, and having a plurality of angle adjustment grooves into one of which the angle adjustment rod is inserted.

10. The stretching apparatus of claim 9, wherein the body frame further includes a plurality of connection frames connecting the plurality of horizontal frames to each other in a left and right direction, and
one connection frame adjacent to the second stretching member among the plurality of connection frames is arranged on a same axis as the rotation axis of the second stretching member.

11. The stretching apparatus of claim 10, wherein the connection frame adjacent to the second stretching member is arranged below the second stretching member.

12. The stretching apparatus of claim 9, wherein the rotation support includes a plurality of protruding regions that protrude to define the plurality of angle adjustment grooves, and
the plurality of protruding regions are arranged to be separated from each other in a vertical direction and include a plurality of first protruding regions having a first protrusion height and a plurality of second protruding regions having a second protrusion height, the first protrusion height being different from the second protrusion height.

13. The stretching apparatus of claim 12, wherein the plurality of first protruding regions are arranged at both end portions of the rotation support in the vertical direction and have the first protrusion height that is greater than the second protrusion height, and
the plurality of second protruding regions are arranged between the plurality of first protruding regions in the rotation support.

14. The stretching apparatus of claim 9, wherein the rotation angle adjuster includes:
a rotation shaft; and
an angle adjustment handle connecting the rotation shaft to the angle adjustment rod and configured to rotate the angle adjustment rod about the rotation shaft.

15. A stretching apparatus comprising:
a body frame;
a stretching member configured to adjust an angle thereof with respect to the body frame and to support a part of a user's body; and
a rotation angle adjuster configured to rotate the stretching member about a preset rotation axis with respect to the body frame,
wherein the body frame includes a plurality of support frames and a plurality of horizontal frames having both end portions supported by the plurality of support frames, and
the rotation angle adjuster includes an angle adjustment rod arranged below the stretching member and a rotation support fixed to the body frame, supporting the stretching member to rotate about the rotation axis, and having a plurality of angle adjustment grooves into one of which the angle adjustment rod is inserted.

16. The stretching apparatus of claim 15, wherein the body frame further includes a plurality of connection frames connecting the plurality of horizontal frames to each other in a left and right direction, and
one connection frame adjacent to the stretching member among the plurality of connection frames is arranged on a same axis as the rotation axis of the stretching member.

17. The stretching apparatus of claim 16, wherein the connection frame adjacent to the stretching member is arranged below the stretching member.

18. The stretching apparatus of claim 15, wherein the rotation support includes a plurality of protruding regions that protrude to define the plurality of angle adjustment grooves, and
the plurality of protruding regions are arranged to be separated from each other in a vertical direction and include a plurality of first protruding regions having a first protrusion height and a plurality of second protruding regions having a second protrusion height, the first protrusion height being different from the second protrusion height.

19. The stretching apparatus of claim 18, wherein the plurality of first protruding regions are arranged at both end portions of the rotation support in the vertical direction and have the first protrusion height that is greater than the second protrusion height, and
the plurality of second protruding regions are arranged between the plurality of first protruding regions in the rotation support.

20. The stretching apparatus of claim 15, wherein the rotation angle adjuster includes:
a rotation shaft; and
an angle adjustment handle connecting the rotation shaft to the angle adjustment rod and configured to rotate the angle adjustment rod about the rotation shaft.
